(19) United States
(12) Patent Application Publication
(10) Pub. No.: US 2024/0332666 A1
(43) Pub. Date: Oct. 3, 2024

(54) BATTERY MODULE WITH TERMINAL COOLING AND METHOD FOR PRODUCING A BATTERY MODULE

(71) Applicant: AUDI AG, Ingolstadt (DE)

(72) Inventors: Waldemar BAUER, Manching (DE); Florian EIDMANN, Öhringen (DE); Jens FRONEMANN, Simmelsdorf (DE); Eduard MAIN, Buxheim (DE); Martin MOISSL, Wettstetten (DE)

(73) Assignee: AUDI AG, Ingolstadt (DE)

(21) Appl. No.: 18/599,581

(22) Filed: Mar. 8, 2024

(30) Foreign Application Priority Data
Mar. 31, 2023 (DE) 102023108283.3

(51) Int. Cl. H01M 10/653; B60R 16/033; H01M 10/613; H01M 10/625; H01M 10/6556; H01M 10/656; H01M 50/209; H01M 50/262

(52) U.S. Cl. CPC H01M 10/653; H01M 10/613; H01M 10/625; H01M 10/6556; H01M 10/656; H01M 50/209; H01M 50/262; B60R 16/033; H01M 2220/20

(57) ABSTRACT

A battery module for a motor vehicle, including a cell stack with a first stack side and with a plurality of battery cells, each of which has a first pole terminal on a first cell side which is part of the first stack side, and including a module housing in which the cell stack is arranged and which has a cooling cover. A space is formed between the first stack side and the cooling cover, which space is only partially filled with the heat-conducting compound, so that at least a contiguous first partial region of the space, which is located between the first pole terminals and the cooling cover, is completely filled with the heat-conducting compound, and a second partial region of the space.

### FIELD

The invention relates to a battery module for a motor vehicle, wherein the battery module comprises a cell stack which has a first stack side and a plurality of battery cells arranged next to one another in a first direction, each of which has a first cell side which delimits the respective battery cells in a second direction and on which at least one first pole terminal of a respective battery cell is arranged, which is part of the first stack side of the cell stack or faces the first stack side. Furthermore, the battery module comprises a module housing in which the cell stack is arranged, wherein the module housing has a cooling cover through which a coolant can flow, which is arranged opposite the first stack side, wherein an intermediate space is formed between the first stack side and the cooling cover, in which a heat-conducting compound is formed is arranged. Furthermore, the invention also relates to a method for producing a battery module.

### BACKGROUND

Battery modules, especially those for high-voltage batteries, are usually cooled by cooling devices. A high-voltage battery typically comprises multiple battery modules, wherein such battery modules in turn can comprise multiple battery cells, for example prismatic individual cells, which are arranged in the form of a cell pack or cell pile or cell stack. Excessive heating of these individual battery cells has a negative effect on their service life as it accelerates the aging of these battery cells. Accordingly, it is desirable to always keep the temperature of such battery cells in a desired temperature range, which has the least negative impact on the service life of the battery cells and is therefore optimal for the operation of these battery cells. The cooling devices usually used to cool battery modules are typically arranged on the underside of such battery modules, that is to say on one side of the battery modules, which is arranged opposite the poles of the individual battery cells. In this region, it is easiest to provide large-region cooling, for example through cooling plates through which a coolant can flow. In general, such a cooling device can also be arranged on other sides of a battery module, as well as between the individual battery cells of the battery module. In certain situations, however, it may happen that the cooling capacity that can be provided by such a cooling device is not sufficient to keep the battery cells in the desired temperature range. This can happen, for example, when there is a high power requirement while driving, or during a charging process to charge the high-voltage battery. Accordingly, in such situations, in order to be able to keep the battery cells in the desired temperature range, the power that can be used for driving or the charging power for charging the high-voltage battery is limited. When driving, this disadvantageously reduces the maximum power that can be provided by a motor vehicle and when charging the high-voltage battery, this leads to a significantly longer charging time.

It would therefore be desirable to allow the most efficient cooling of a battery module. DE 10 2020 133 255 A1 describes a battery arrangement with a battery housing that has a lower housing part and a housing cover arranged on the lower housing part. In addition, the battery arrangement comprises a battery module arranged in the battery housing, which comprises at least one battery cell, wherein an upper side of the battery module faces the housing cover and is at a distance from the housing cover in at least one region of the upper side. Furthermore, a heat-conducting compound which completely fills the space between the region of the upper side and the housing cover is arranged between the upper side of the battery module and the housing cover, the battery arrangement having at least one sealing element which at least partially seals the intermediate space. Intermediate spaces between the upper side of a battery module and a housing cover, which can also represent a cooling cover, should be completely filled with a casting compound or heat-conducting compound in order to make the thermal connection as effective as possible and to avoid thermally insulating air pockets. This allows a good thermal connection between the housing cover and the battery module. In addition, tolerance-related height differences in different regions of the cell upper sides can be compensated for.

However, when filling such a space, further problems arise: sufficient heat-conducting compound must be provided in this space to ensure that the housing cover is electrically insulated from the cell poles by the heat-conducting compound. On the other hand, large amounts of heat-conducting compound have the disadvantage that they increase the total weight of the battery module, that they lead to a large thickness of the heat-conducting compound layer, which in turn reduces the thermal resistance of the thermal transmission path from the battery module to the cooling cover, and that a large height of the space also leads to an increased space requirement and.

### SUMMARY

The object of the present invention is to provide a battery module and a method that allow the most efficient possible thermal connection of a battery module to a cooling cover of a module housing.

A battery module for a motor vehicle according to the invention comprises a cell stack which has a first stack side and a plurality of battery cells arranged next to one another in a first direction, each of which has a first cell side which delimits the respective battery cells in a second direction and on which at least one first pole terminal of a respective battery cell is arranged, which is part of the first stack side of the cell stack or faces the first stack side. Furthermore, the battery module has a module housing in which the cell stack is arranged, the module housing having a cooling cover through which a coolant can flow and which is arranged opposite the first stack side, a space being formed between the first stack side and the cooling cover, in which a heat-conducting compound is arranged. The space is only partially filled with the heat-conducting compound, so that at least a contiguous first partial region of the space, which is located between the first pole terminals and the cooling cover, is completely filled with the heat-conducting compound, and a second partial region of the space, which adjoins the first partial region with respect to a third direction, represents a collecting region for the heat-conducting compound and is at most only partially filled with the heat-conducting compound. The invention is based on the knowledge that when battery cells heat up, a significant amount of heating occurs in the region of the pole terminals. A very high cooling efficiency can therefore already be achieved if cooling, as provided here by the cooling cover, is connected as much as possible to the pole terminals, namely via the heat-conducting compound, which in the present case is arranged at least in the first partial region between the first pole terminals and the cooling cover and fills this partial region completely. This makes it possible to provide a particularly good thermal connection of the first pole terminals to the cooling cover. A thermal connection of regions of the first cell sides in which no pole terminals are arranged is therefore not necessary, since no significant increase in cooling efficiency can be achieved in this way anyway. This knowledge can now be used in a particularly advantageous manner to design a second partial region adjacent to the first partial region in such a way that it is not or only partially filled with the heat-conducting compound. This adjacent second partial region of the space can be used, so to speak, as a collecting region or collecting basin during the production of the battery module in order to collect excess and still viscous heat-conducting material that flows out of the first partial region due to this pressing process when the cooling cover is pressed in the direction of the battery module. This in turn results in further advantages, because this also enables, for example, particularly small space heights between the first pole terminals and the cooling cover or particularly small heights of the first partial region filled with the heat-conducting compound, the height of which can be adjusted to a desired height by the pressing process described. This does not require, for example, positioning the exact amount of heat-conducting compound in this first partial region, since excess heat-conducting compound can simply be displaced into the collecting region. On the one hand, this makes it possible to optimally compensate for height tolerances in relation to the second direction, to provide the smallest possible space heights and the smallest possible layer thicknesses of the thermally conductive layer, particularly small overall heights of the battery module in the second direction, and a particularly efficient thermal connection of the battery module to a cooling cover.

In the present case, the battery cells are lithium-ion cells, for example. In addition, the battery cells can be designed, for example, as prismatic battery cells. Each of the battery cells comprises two pole terminals. Optionally, as explained in more detail later, not only the first pole terminal can be arranged on a respective first cell side of a battery cell, but also the second pole terminal. In this case, the pole terminals are at a certain distance from one another, particularly in the third direction, whereby the collecting region can be provided. In addition, the first pole terminals can be electrically connected to one another via cell connectors, as can the second pole terminals to one another. These cell connectors can therefore also be part of the terminal regions of the first stack side explained later.

The heat-conducting compound is preferably designed to be electrically insulating. This means that the heat-conducting compound can simultaneously be used as an electrical insulator between the pole terminals or the cell connectors located on the pole terminals, and, for example, the cooling cover. However, it is also conceivable to provide an additional electrical insulation element, for example an insulation film, as will be explained in more detail later. The heat-conducting compound is, for example, a so-called gap filler, that is, a gap filler that has the best possible heat-conducting properties. The thermally conductive compound can also generally be referred to as a thermal interface material. In principle, the use of a thermally conductive adhesive as a thermally conductive compound would also be conceivable. However, this is not preferred in the present case. The thermally conductive compound is viscous during the production of the battery module, when the thermally conductive compound is introduced into or applied to the corresponding regions of the battery module to be manufactured, and then hardens when the components to be arranged on the thermally conductive compound have been brought into their intended position. When the battery module is finished, the thermally conductive compound is solid and no longer viscous.

The battery cells of the cell stack are preferably designed in the same way. Their pole terminals are also preferably located in the same position. The first pole terminals are then arranged, for example, on a straight line. This simplifies the thermal connection to the battery cells. The first partial region of the space can therefore also extend in a straight line across all of the first pole terminals, in particular contiguously.

At least the first pole terminals or the cell connectors connected thereto are part of the first stack side of the cell stack. If the cell connectors are located in the second direction above the pole terminals, then only the cell connectors can be considered part of the first stack side, and the pole terminals then face the first stack side accordingly. However, the cell connectors can also be designed and positioned differently, for example next to the pole terminals, contacting them laterally. Optionally, the first cell sides, in particular including the cell connectors mentioned, can also be entirely part of the first stack side. The first stack side of the cell stack can also be formed entirely by the first cell sides of the battery cells included in the cell stack. However, it can also be provided that only the pole terminals arranged on the first cell side, i.e. the first pole terminals and optionally the second pole terminals described later, are part of the first stack side. On the remaining region of the first cell side that is different from the pole terminals, for example comprising the region between the two pole terminals of a respective cell, there can be a cover that is part of the first stack side. The first stack side can then be formed, for example, by this cover and the pole terminals, which protrude, for example, through recesses in this cover, or can comprise these components.

The first direction is preferably perpendicular to the second direction and the third direction is preferably perpendicular to the first and second directions. The first, second and third directions are essentially perpendicular in pairs to one another.

The cooling cover is designed to allow coolant to flow through it. For this purpose, the cooling cover can have, for example, cooling channels or cooling channel portions of a cooling channel. The cooling cover itself is preferably made of a metallic material, as this allows heat conduction to be optimized. However, a design made of a plastic, in particular fiber-reinforced plastic, is also conceivable. In addition to the cooling cover, the module housing can also have other housing components, for example a frame surrounding the cell stack. The cooling cover can be arranged on this frame, for example. In addition, the module housing can optionally also include a housing base, but this does not necessarily have to be the case. The battery module can also be arranged as a whole on a cooling base, which is provided by the base of an overall battery housing in which multiple of the battery modules are accommodated. However, each of these battery modules preferably has its own cooling cover, which is therefore part of the respective module housing, as this enables a precise fit.

In particular, a motor vehicle battery, preferably a high-voltage battery, can be provided by multiple such battery modules. The battery module is preferably a battery module for a high-voltage battery of a motor vehicle. The second direction can in particular correspond to a vehicle vertical direction of a motor vehicle vertical axis based on a preferred installation position of the battery module in the motor vehicle. Accordingly, the cooling wall of the module housing, which represents the cooling cover, is also referred to as a cover. Nonetheless, any other installation position in a motor vehicle is also conceivable.

The intermediate space between the first stack side and the cooling cover has at least some empty spaces. In principle, it is also conceivable to fill the partial regions of the space that are not filled with the heat-conducting compound in another way. However, casting with a casting compound is not preferred, so it is correspondingly preferred that this intermediate space at least partially comprises empty spaces, for example air-filled empty spaces. This also has advantages in terms of weight.

According to a further advantageous embodiment of the invention, the battery cells each have a second pole terminal on their first cell side, the space comprising a third partial region which is located between the second pole terminals and the cooling cover and which is completely filled with the heat-conducting compound or with a further heat-conducting compound. However, this is preferably a thermal compound of the same type or type as the heat-conducting compound, which also fills the first partial region. The same should apply in particular to the heat-conducting compounds, which will be mentioned in relation to further exemplary embodiments of the invention and which, for example, fill the optional fourth and sixth and at most partially fifth partial regions of the space, which will be explained in more detail later.

This means that the second pole terminals of the cells, which are also located on the first side of a respective battery cell, can also advantageously be efficiently connected to the cooling cover.

In a further advantageous embodiment of the invention, the first stack side comprises a first terminal region which extends in a straight line in the first direction and which comprises the first pole terminals of the battery cells, wherein a first stack side comprises a second terminal region which extends in a straight line in the first direction and which comprises the second pole terminals of the battery cells, wherein the first and second terminal regions are at a distance from one another in the third direction, wherein the collecting region is arranged between the first terminal region and the second terminal region. The collecting region can therefore advantageously be formed between the two terminal regions. The pole terminals typically protrude slightly beyond the remaining region of the first cell sides. There is therefore a certain depression between the two pole terminals of a cell, which can advantageously be used across the cell stack as a collecting region for the excess heat-conducting material in the manufacturing process.

In a further advantageous embodiment of the invention, the battery module has a sealing frame which is arranged all around the space or a partial space encompassed by it, in particular along an edge region of the first stack side. This sealing frame can be arranged circumferentially along the entire edge region of the first stack side. This sealing frame can advantageously ensure that the heat-conducting compound cannot run out of the space formed between the cooling cover and the cell stack during the manufacturing process or that it cannot flow out of this space or be pushed out. Excess heat-conducting material can therefore be directed specifically to the collection region during the manufacturing process. This simplifies the manufacturing process.

The sealing frame can be designed to be incompressible, so to speak as a raised, rigid side wall, or can also comprise an elastic seal or be designed as such. The sealing frame can also be designed in two parts and have a first, incompressible first frame part on which a seal is arranged in the second direction. This also means that the sealing frame can be designed to be somewhat flexible or elastically deformable, at least with respect to the second direction. For example, the sealing frame can, on the one hand, rest on or be arranged on the edge region of the cell stack, and on the other hand, rest against the cooling cover, preferably with the soft or elastic sealing part. Alternatively, the sealing frame can only rest on the heat-conducting plate with its sealing part, which will be explained in more detail later. The seal can be provided by a foam seal which is located on the surrounding frame, i.e. the first frame part. It is also conceivable that this sealing frame is provided by protruding side walls of the module housing, which are provided with a seal, for example a foam seal, on the upper side.

According to a further advantageous embodiment of the invention, the battery module has a heat-conducting plate which is arranged in the space and which divides the space in the second direction into a first partial space and a second partial space, wherein the first and the second partial regions and in particular also the third partial region are also arranged in the first partial space between the heat-conducting plate and the first stack side. The heat-conducting plate acts, so to speak, as an intermediate plate that divides the space into two partial spaces, namely the first partial space and the second partial space. The second partial space is then arranged above the first partial space in relation to the second direction. The heat-conducting plate can also have openings, so that the first and second partial spaces can in principle be connected through these openings. However, the heat-conducting plate is preferably designed as a closed plate, that is, it preferably has no openings. If necessary, ventilation openings can be provided in the heat-conducting plate in order to allow air to escape from the first partial space during the pressing process. However, such ventilation openings can also be provided elsewhere. Such an additional heat-conducting plate, which is located, so to speak, as an intermediate plane between the first stack side of the cell stack and the cooling cover, has multiple advantages: Above all, this makes any dismantling of the battery module significantly easier. If the cooling cover needs to be removed from the battery module for any reason, for example in the event of a repair, this is made much easier with an additional heat-conducting plate. Scraping the cooling cover, which is also connected to the heat-conducting plate via a heat-conducting compound, is thus simplified and at the same time any possible mechanical impairment or damage to the cell stack is prevented. The heat-conducting plate thus serves as additional protection for the cell stack. When it comes to, for example, the penetration of liquids or dust or the like into the battery module, the heat-conducting plate takes on an additional protective function. It is therefore preferred that the heat-conducting plate is designed without openings, since this makes the penetration of liquids even more difficult. The heat-conducting plate is preferably formed from a metallic material, which in turn provides particularly good thermal conductivity through the heat-conducting plate. The heat-conducting plate can be made of aluminum and/or steel, for example.

In principle, an embodiment without such a heat-conducting plate is also conceivable. In such a case, for example, the first partial region and/or the third partial region of the space would extend from the first stack side to the cooling cover. In this case, the heat-conducting compound that completely fills the first partial region or the third partial region will, on the one hand, directly contact the first stack side, in particular directly also the first pole terminals or the second pole terminals or the cell connectors arranged thereon, and, on the other hand, directly contact the cooling cover. With the heat-conducting plate, the first and third partial regions are now each limited to the first partial space between the heat-conducting plate and the cell stack.

In order to improve the thermal connection of the heat-conducting plate to the cooling cover, it is again preferred here that the second partial space is at least partially filled with a heat-conducting compound. Therefore, it represents a further very advantageous embodiment of the invention if a fourth partial region is arranged in the second partial space in the second direction directly above the first partial region, which is filled with a heat-conducting compound, in particular where the fourth partial region extends from the heat-conducting plate to the Cooling cover extends, and/or a fifth partial region is arranged in the second direction directly above the second partial region, which is at most only partially filled with a heat-conducting compound, and/or a sixth partial region is arranged in the second direction directly above the third partial region, which is filled with a heat-conducting compound, in particular wherein the sixth partial region extends from the heat-conducting plate to the cooling cover. The fifth partial region can in turn function as a collecting region for the excess gap filler or the excess heat-conducting compound in the manufacturing process. The heat-conducting plate is now advantageously connected to the cooling cover via the fourth partial region and the sixth partial region. This fourth partial region and the sixth partial region are located directly above the first partial region and the third partial region, respectively, which in turn are arranged directly above the pole terminals. This provides a particularly good thermally conductive path from the pole terminals to the cooling cover via the heat-conducting plate.

According to a further advantageous embodiment of the invention, the battery module comprises at least one electrically insulating film which is arranged in the intermediate space and which is preferably arranged at least on the first terminal region of the first stack side between the first terminal region and the heat-conducting compound in the first partial region, and in particular also on the second terminal region of the first stack side between the second terminal region and the heat-conducting compound located in the third terminal.

Such an electrically insulating film can optionally provide additional insulation between the cell stack and the cooling cover and/or the heat-conducting plate. This can further increase security. In addition, the requirements for the heat-conducting compound with regard to its electrically insulating properties can be significantly lower or eliminated entirely. A minimum thickness of the thermally conductive compound to ensure electrical insulation is also not required. This enables even smaller space heights or layer thicknesses of the heat-conducting compound layers. It is preferred that such a film is arranged on the first terminal region, for example continuously. Another film can be arranged on the second terminal region and thus cover all second terminals. In principle, it is also conceivable, although less preferred, for a film to cover the entire first side of the stack. This would require a more complex lining of the first stack side with such an electrically insulating film. The film can protrude slightly beyond the first and second terminal regions in the third direction. This creates a certain safety tolerance range, which ensures that the first and second terminals are reliably covered with the respective film. Alternatively or additionally, it is also conceivable that such an electrically insulating film is arranged on a side of the cooling cover and/or the heat-conducting plate facing away from the cell stack. This also makes it possible to provide reliable electrical insulation between the cooling cover or the heat-conducting plate on the one hand and the cell stack on the other. If a heat-conducting plate is present, additional electrical insulation in the form of such a film between the cooling cover and the heat-conducting plate is not necessary. These can also be in electrically conductive contact without running the risk of any short circuit, since both components are not live components.

The film can be a plastic film. This allows a very simple and cost-effective design of an electrically insulating film.

According to a further advantageous embodiment of the invention, the module housing has two side walls, which are arranged essentially perpendicular to the third direction, and which are each connected to the heat-conducting plate in a material-locking manner, in particular are welded to it. This allows a particularly stable connection to be established between the heat-conducting plate and the side walls. In addition to the two side walls, the module housing can also have two end plates which delimit the cell stack in and against the first direction and connect the two side walls to one another. The end plates, together with the side walls, form a frame around the cell stack. The end plates do not necessarily have to be attached to the heat conduction plate.

According to a further advantageous embodiment of the invention, the battery module has at least one spacer made of an electrically insulating material, which is arranged on the first stack side, in particular in the second partial region. The at least one spacer preferably projects higher in the second direction than the pole terminals. Such a spacer can advantageously ensure that there is always a certain minimum distance between the pole terminals and the cooling cover or, if present, the heat-conducting plate. This means that a certain minimum layer thickness of thermally conductive compound can be guaranteed on the pole terminals. This is not only advantageous in the absence of the heat-conducting plate for reliable electrical insulation, which can in principle also be implemented using an additional insulating film, but above all this is advantageous for reasons of stability and enables a reliable thermal connection to the cooling cover, even in the case of mechanical ones Stresses and movements that occur during operation, especially while driving.

The at least one spacer can be designed as a point spacer or as spatially separated distance points which are arranged on the respective first cell sides or the first stack side in the region in which there are no terminals. However, the spacer can also be designed as a type of frame and extend over all first cell sides of the battery cells or the first stack side of the cell stack. This frame can, for example, be designed with a recess or recess in the region that adjoins the pole terminals or is arranged adjacent to them with respect to the third direction, that is to say it can be designed to be lower in the second direction in order to prevent the excess heat-conducting material from running in to enable the collecting region during production, since this collecting region can be located within this distance frame. The frame or another spacing structure can also be formed by the spacing points described above and connecting struts connecting them to one another, wherein the connecting struts can be lower with respect to the second direction than the spacing points. Such a spacer frame or such a spacer structure simplifies the arrangement on the cell stack, since numerous individual spacers do not have to be applied to the cell stack. According to a further advantageous embodiment of the invention, the battery module comprises at least one height tolerance-compensating fastening means, by means of which the cooling cover is fastened to a housing component of the module housing, for example to one of the above-mentioned end plates. Such a height tolerance compensating fastening means can be designed in such a way that the fastening process for fastening the cooling cover to the rest of the module housing via this fastening means is reversible, that is, non-destructively reversible. For example, the cooling cover can be screwed on or the fastening means can be provided via a type of clip or locking element, which is adjustable in the second direction with regard to its locking position. This makes it easier to remove the cooling cover from the rest of the battery module, especially in the event of a repair.

Furthermore, the invention also relates to a high-voltage battery for a motor vehicle, wherein the high-voltage battery has one battery module according to the invention or one of its embodiments. Such a high-voltage battery preferably comprises multiple battery modules according to the invention or multiple battery modules according to exemplary embodiments of the invention.

Furthermore, the invention also relates to a motor vehicle having a battery module according to the invention or one of its embodiments.

The motor vehicle according to the invention is preferably designed as an automobile, in particular as a passenger car or truck, or as a passenger bus or motorcycle.

Furthermore, the invention also relates to a method for producing a battery module for a motor vehicle, wherein a cell stack arranged in a receptacle is provided with a first stack side and with a plurality of battery cells arranged next to one another in a first direction, each of which has a first cell side which delimit the respective battery cell in a second direction and on which at least one first pole terminal of a respective battery cell is arranged, which is part of the first stack side of the cell stack. Furthermore, a cooling cover through which a coolant can flow is provided, as well as a heat-conducting compound. Furthermore, the heat-conducting compound, the cell stack and the cooling cover are arranged relative to one another in such a way that the cooling cover is opposite the first stack side and an intermediate space is formed between the first stack side and the cooling cover, in which at least part of the heat-conducting compound is arranged. The space is only partially filled with the heat-conducting compound, so that at least a contiguous first partial region of the space, which is located between the first pole terminals and the cooling cover, is completely filled with the heat-conducting compound, and a second partial region of the space, which adjoins the first partial region with respect to a third direction, represents a collecting region for the heat-conducting compound and is at most only partially filled with the heat-conducting compound.

The advantages described in relation to the battery module according to the invention and its embodiments apply in the same way to the method according to the invention.

The invention also comprises developments of the method according to the invention, which have the same features which have already been described in conjunction with the developments of the battery module according to the invention. For this reason, the corresponding developments of the method according to the invention are not described again here.

The invention also comprises the combinations of the features of the described embodiments. The invention therefore also comprises implementations that respectively have a combination of the features of multiple of the described embodiments, provided that the embodiments have not been described as mutually exclusive.

### BRIEF DESCRIPTION OF THE FIGURES

Exemplary embodiments of the invention are described hereinafter. In the figures:

FIG. 1 shows a schematic representation of a battery module according to one exemplary embodiment of the invention.

FIG. 2 shows a schematic and perspective representation of the battery module from FIG. 1 from obliquely below;

FIG. 3 shows a schematic and perspective representation of a part of the battery module from FIG. 1 according to an exemplary embodiment of the invention; and

FIG. 4 shows a schematic exploded representation of a battery module according to a second exemplary embodiment of the invention;

FIG. 5 shows a schematic and perspective representation of a part of the battery module from FIG. 4; and

FIG. 6 shows a schematic representation of a part of the battery module from FIG. 4 to illustrate the height tolerance compensating fastening means for fastening the cooling cover according to an exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, same reference numerals respectively designate elements that have the same function.

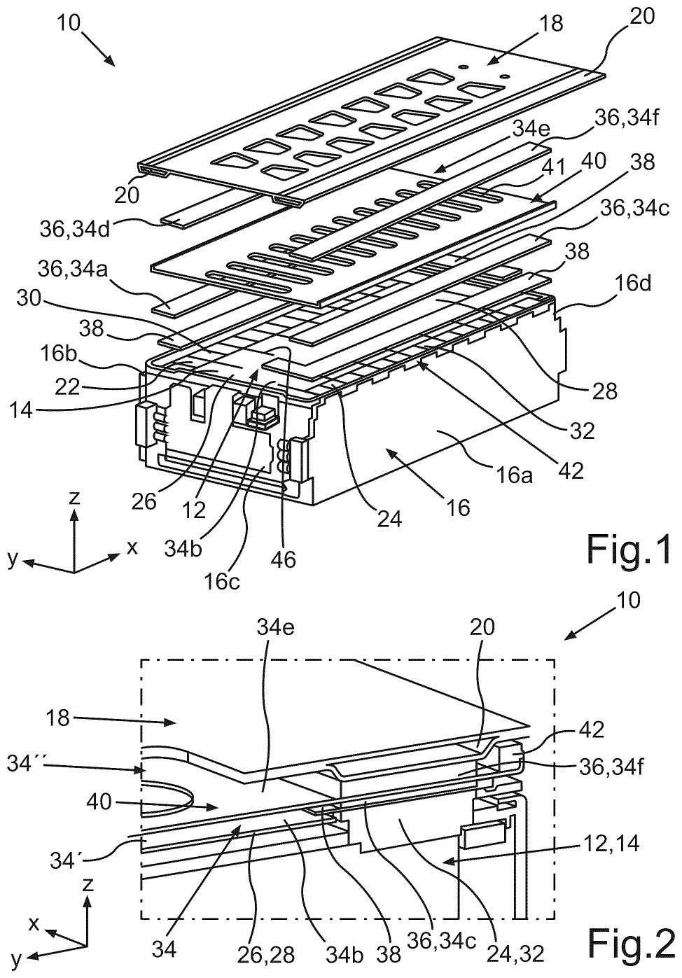

FIG. 1 shows a schematic representation of a battery module 10 according to an exemplary embodiment of the invention. The battery module 10 has a cell stack 12 with a plurality of battery cells 14 arranged next to one another in a stacking direction. The stacking direction corresponds in this case to the x direction of the illustrated coordinate system. The battery module 10 also comprises a module housing 16. The module housing in turn comprises two side plates 16a, 16b, which lie opposite one another and which are aligned essentially parallel to the x-z plane shown. In addition, the housing 16 comprises two end plates 16c, 16d, which delimit the cell stack 12 in and against the x direction. The end plates 16c, 16d connect the side plates 16a, 16b or side walls 16a, 16b of the housing 16 to one another at the ends. In addition, in this case the housing 16 also comprises a cooling cover 18. The cooling cover 18 has cooling channels 20 through which a cooling medium can flow. In order to connect this cooling cover 18 thermally as good as possible to the battery cells 14 and to electrically insulate it from them, the following structure is proposed:

The battery cells 14 each have two pole terminals 22, 24. Each cell 14 has a first pole terminal 22 and a second pole terminal 24, with only one pole terminal 22, 24 being provided with a reference number for reasons of clarity. In addition, for reasons of clarity, the cell connectors connecting the pole terminals 22, 24 are not shown.

The cell sides of the battery cells 14 facing the cooling cover 18 are also referred to as first sides 26. The pole terminals 22, 24 are therefore arranged on the first cell sides 26 of the cells 14. The first cell sides 26 of the battery cells 14 can in turn be at least partially part of a first stack side 28 of the cell stack 12. At least the first and second pole terminals 22, 24 are part of the first stack side 28. The first stack side 28 thus has a first terminal region 30 which extends in a straight line in the x direction and in which the first pole terminals 22 of the cells 14, and in particular the cell connectors connecting the first pole terminals 22 are also arranged, and a second terminal region 32, which also extends in a straight line in the x direction, and in which the second pole terminals 24 of the cells 14 and in particular also the cell connectors connecting the second pole terminals 22 are arranged.

If the cooling cover 18 is arranged as intended on the rest of the battery module 10, in particular on the rest of the housing 16, a space 34 (see FIG. 2) is formed between the cover 18 and the cell stack 12, in particular the first stack side 28. This is at least partially filled with a heat-conducting compound 36. However, this space 34 is not completely filled with the heat-conducting compound 36, but only partially. For better description, this space 34 can be divided into multiple partial regions or partial spaces, as will be explained in more detail later.

First of all, in this example, the battery module 10 also comprises at least one electrically insulating film 38. In this example, the battery module 10 comprises multiple such films 38. These electrically insulating films 38 are arranged directly on the first stack side 28 of the cell stack 12, in such a way that at least all first pole terminals 22 and all second pole terminals 24 are covered by such a film 38. Other live components or components that carry current during operation can also be covered by such a film 38, such as connecting lines that lead from the cell poles 22, 24 to a module connection of the battery module 10, or other module connectors or cell connectors. Therefore, the films 38 shown here are not only limited to the corresponding terminal regions 30, 32, but also partially extend beyond them. When producing such a battery module 10, for example, these films 38 can first be applied to the cell stack 12 arranged in the frame of the housing 16, in particular on the first stack side 28, in particular at the position as just described. A heat-conducting compound layer 36 can then be arranged in the z direction directly above the respective terminal regions 30, 32, which is shown and designed in the form of a strip in the present case. During production, for example, a viscous heat-conducting mass bead or heat-conducting mass track can be applied along the respective terminal regions 30, 32, in particular on the optimal film 38. Through a pressing process, in which at least one component applied from above onto the heat-conducting compound tracks, for example the heat-conducting plate 40 described in more detail later or the cooling cover 18 itself, is pressed, the heat-conducting compound tracks are pressed in width, i.e. in or against the third direction y, which results in the flat, strip-shaped geometry. Excess heat-conducting compound 36 can run into the collecting region 34b, which will be described in more detail later.

A first such strip of heat-conducting compound 36 then corresponds to a first partial region 34a of the intermediate region 34, and a second strip of the heat-conducting compound 36 corresponds to a third partial region 34c of the intermediate region 34. In the assembled state, a second partial region 34b ultimately lies between these two partial regions 34a, 34c, which second partial region acts as the aforementioned collecting region 34b for the heat-conducting compound 36 during production. After the heat-conducting compound 36 has been applied to the corresponding films 38 above the respective terminal regions 30, 32, in this example a heat-conducting plate 40 is first placed onto the heat-conducting compound strips 36 from above, that is against the z-direction. The heat-conducting compound 36, which is still viscous in this state, can thus be at least partially pressed into this collecting region 34b. In order to prevent lateral leakage of the heat-conducting compound 36, the battery module 10 can also have a circumferential frame 42, which is preferably either completely designed as a sealing element and is designed to be elastic or flexible, or designed with a seal in the upper part with respect to the z direction. To connect the heat-conducting plate 40 to the cooling cover 18, two further layers or strips of heat-conducting compound 36 can be applied to the heat-conducting plate 40. A further strip of heat-conducting compound 36 then corresponds accordingly to a fourth partial region 34d of the space 34 and another strip to a sixth partial region 34f of the space 34, with a fifth partial region 34e of the space 34 being formed in the y direction between these two partial regions 34d, 34f is, into which no heat-conducting compound 36 is applied during the manufacturing process, and which in turn can act as a collecting region during the extortion. The cooling cover 18 can then be placed onto these additional thermally conductive material strips 36 from above.

The intermediate plate 40 is preferably welded to the side walls 16a, 16b of the housing 16. This creates a very stable module composite. The cooling cover 18 can be attached to the module 10, in particular to the housing frame of the housing 16, for example to the end plates 16c, 16d, via height tolerance-compensating fastening means 44 (see FIG. 6), which will be explained in more detail later.

In the present example, the intermediate plate 40 is formed with openings 41, of which only one is provided with a reference number for reasons of clarity. These openings 41 serve to reduce weight and are only optional. The intermediate plate 40, which is preferably made of metallic material, can also be designed without such openings 41.

This has the advantage that the tightness of the overall composite of intermediate plate 40 and the lower housing part of the module housing 16 is increased. Penetration of liquid into the module 10 is therefore made even more difficult.

In addition, spacer elements 46 can be arranged on the first stack side 28. In this example, these are shown as strips and extending in the y-direction. However, these can also have any other geometry. The spacer elements 46 are designed to be electrically insulating and ensure a certain minimum distance between the sheet 40 and the first stack side 28. FIG. 2 shows a schematic cross-sectional representation of a part of the battery module 10 from FIG. 1. The battery module 10 is shown in an assembled state or in a fully manufactured state. As can be seen, the intermediate plate 40 divides the space 34 between the cell stack 12 and the cooling cover 18 into a first partial space 34′ below the intermediate plate 40 and a second partial space 34″ above the plate 40. It is also easy to see that the heat-conducting compound 36 filling the third partial region 34c is located above the insulation foil 38 and below the thermal conduction plate 40, and in the corresponding sixth partial region 34f another heat conduction strip 36, which contacts the cover cooling 18 directly in the region of the cooling channel 20.

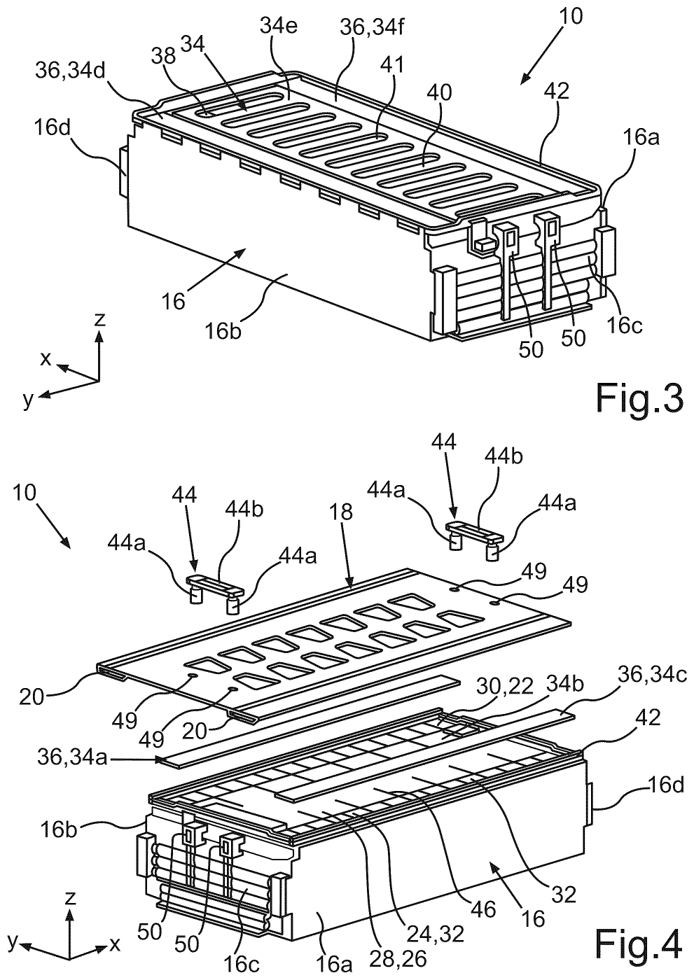

FIG. 3 shows again a schematic and perspective view of the battery module 10 from FIG. 1 in the assembled state without the cooling cover 18, but with the heat-conducting strips 36 arranged on the intermediate plate 40 in the corresponding partial regions 34d, 34f, between which the fifth partial region 34e is arranged.

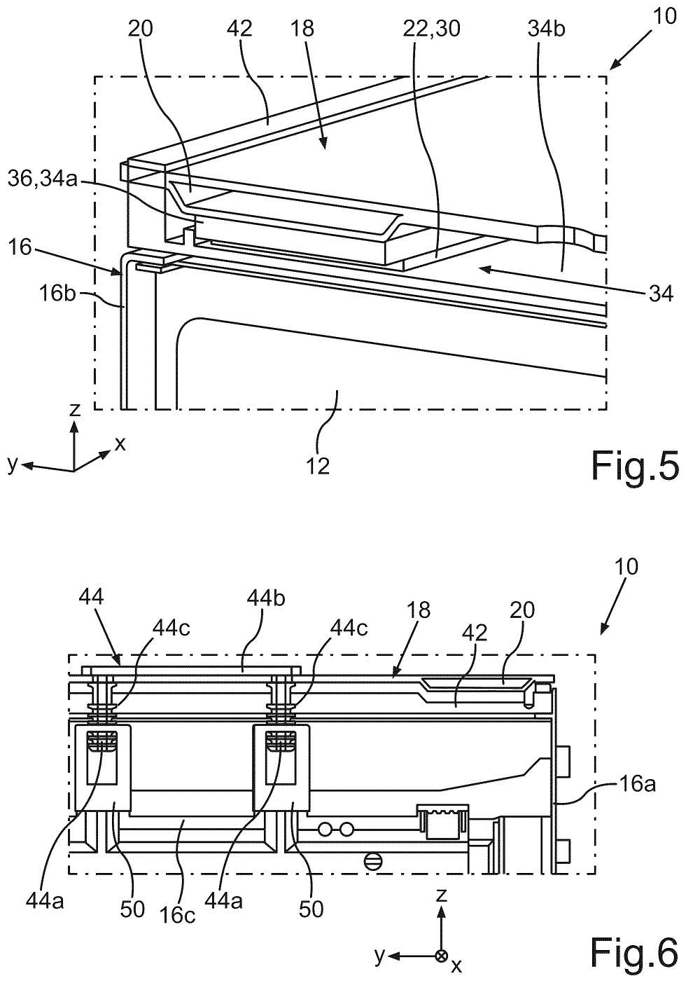

FIG. 4 shows a schematic representation of a battery module 10 according to a further exemplary embodiment of the invention. This can in particular be constructed as before, except for the differences described below: In this example, the battery module 10 does not include an intermediate plate 40. In addition, no electrically insulating film 38 is provided. In this example, two gap filler strips 36 are now arranged directly on the corresponding terminal regions 30, 32 of the first stack side 28. One of these strips in turn corresponds to the first partial region 34a of the space 34 (see FIG. 5) and the other heat-conducting strip 36 corresponds to the third partial region 34c. By eliminating the intermediate plate 40, this intermediate region 34 is no longer divided into a first and second partial intermediate region. Between these two partial regions 34a, 34b, a directly adjoining collecting region 34b is again arranged in the y direction as a second partial region. If the cooling cover 18 is now placed on these heat-conducting strips 36 from above, with the heat-conducting compound 36 still in a viscous state at the time of placement, any excess heat-conducting compound 36 can escape into the collecting region 34b. Here too, a circumferential sealing edge 42 is provided in order to prevent the heat-conducting compound from leaking outside the module 10. Here too, the first stack side 28 can again have spacer elements 46 which protrude further in the z direction than the corresponding pole terminals 22, 24. This ensures a certain minimum layer thickness of the heat-conducting compound 36 when the cooling plate 18 is placed on. To fasten the cooling plate 18 to the rest of the module 10, in particular to the rest of the module housing 16, the height tolerance-compensating fastening means 44 already mentioned can be provided. These can be passed through corresponding openings 50 in the cooling plate. In particular, these fastening means 44 include two locking elements 44a, which are pin-shaped and which are connected to one another via a crossbar 44b. The locking elements 44a can be passed through the openings 50 while the web 44b rests on the upper side of the cooling plate 18. The passed-through locking elements 44a can then be inserted into corresponding receptacles 52, which in this example are provided by the respective end plates 16c, 16d of the housing 16, and locked into them. This is shown again schematically in detail in FIG. 6. FIG. 6 shows in particular a part of the battery module 10 from FIG. 4 in the locked state of the fastening means 44. The locking elements 44a have radially projecting locking rings 44c. These can be inserted into the receptacles 50 with slight deformation. To fasten the cover 18, it can be pressed in the direction of the cell stack 12 until a certain force threshold is reached. In other words, the fastening means 44 can be pressed into the receptacles 50 until a certain force threshold is reached.

FIG. 5 again shows a schematic cross-sectional representation of a part of the battery module 10 from FIG. 4. Here, a gap filler layer 36, ie a thermally conductive mass layer 36, which is located in the first partial region 34a of the space 34, is also shown. This gap filler strip 36 thus thermally connects a cell pole 22 with the cooling channel 20 of the cooling plate 18 located above it. Against the y-direction shown, the first partial region 34a is adjoined by the already described second partial region 34b, which is not or at most partially filled with gap filler material, and which acts as a collecting region 34b for the gap filler mass 36 during the manufacturing process.

These fastening means 44 can also be provided in an analogous manner for the battery module 10 described for FIGS. 1, 2 and 3 for fastening the cooling cover 18. The attachment can be done in a completely analogous way.

Overall, the examples show how the invention can provide a terminal cooling. The battery module can include a cooling channel with good thermal contact resistance, preferably made of metal. The height differences resulting from the cell module and the battery pack can be compensated for using a gap filler layer. This gap filler layer transports the heat generated at the cell poles and this is then dissipated to the cooling medium via the cooling channel. Furthermore, the gap filler layer also takes on the insulating function between the cell poles and the electrically conductive cooling channel, at least according to one embodiment of the invention. Excess gap filler, which is liquid during assembly, can flow between the module and the cooling channel into collecting pockets, which are provided by the collecting regions mentioned. The gap filler flow is limited to the outside via a surrounding frame and a seal, preferably a foam seal. This promotes even wetting of the surfaces. The spacers ensure a minimum gap filler thickness between the cell terminal connector and the cooling channel. This means that the required clearance and creep distances can be maintained. The installation height of the cooling channel can be adjusted according to the gap filler height. Therefore, latching elements, for example the fastening means described, which can be pressed to the appropriate height, preferably in a force-controlled manner, are very advantageous. According to an exemplary embodiment, an additional sheet metal conductor, in particular an intermediate plate or heat-conducting plate, can be arranged on the module side, which is designed to be electrically insulating or is electrically insulated from the cell stack by an insulating film and has the task of optimized heat dissipation. The sheet metal conductor can also be connected to a structural component on the module, which thereby increases the mechanical stability. In addition, a thermally conductive bond is created via the module structure. The cooling channel can be placed on this sheet metal conductor using a gap filler. The electrical insulation is preferably carried out using a separate insulating film above the terminal connector.

1. A battery module for a motor vehicle, comprising:
a cell stack with a first stack side and with a plurality of battery cells arranged next to one another in a first direction, each of which having a first cell side which delimits the respective battery cell in a second direction and on which at least one first pole terminal of a respective battery cell, which is part of the first stack side or faces the first stack side, is arranged; and
a module housing, in which the cell stack is arranged, wherein the module housing has a cooling cover through which a coolant can flow and which is arranged opposite the first stack side, wherein a space is formed between the first stack side and the cooling cover, in which a heat-conducting compound is arranged,
wherein the space is only partially filled with the heat-conducting compound, so that at least a contiguous first partial region of the space, which is located between the first pole terminals and the cooling cover, is completely filled with the heat-conducting compound, and wherein a second partial region of the space, which adjoins the first partial region with respect to a third direction, represents a collecting region for the heat-conducting compound and is at most only partially filled with the heat-conducting compound.

2. The battery module according to claim 1, wherein
the battery cells each have a second pole terminal on their first cell side,
wherein the space comprises a third partial region which is located between the second pole terminals and the cooling cover and which is completely filled with the heat-conducting compound,
wherein the first stack side comprises a first terminal region which extends in a straight line in the first direction and which comprises the first pole terminals of the battery cells,
wherein the first stack side comprises a second terminal region which extends in a straight line in the first direction and which comprises the second pole terminals of the battery cells,
wherein the first and second terminal regions are spaced apart in the third direction, and
wherein the collecting region is arranged between the first terminal region and the second terminal region.

3. The battery module according to claim 1, wherein the battery module has a sealing frame arranged circularly around the space or a partial space encompassed by the same, in particular along an edge region of the first stack side.

4. The battery module according to claim 1, wherein the battery module has a heat-conducting plate arranged in the space, and which divides the space in the second direction into a first partial space and a second partial space, wherein the first partial region and the second partial region, and in particular also the third partial region, are arranged in the first partial space between the heat conduction plate and the first stack side.

5. The battery module according to claim 1, wherein in the second partial space: a fourth partial region is arranged in the second direction directly above the first partial region, which is filled with a heat-conducting compound, in particular wherein the fourth partial region extends from the heat-conducting plate to the cooling cover; and/or
a fifth partial region is arranged in the second direction directly above the second partial region, which is at most only partially filled with a heat-conducting compound; and/or
a sixth partial region is arranged in the second direction directly above the first partial region, which is filled with a heat-conducting compound, in particular wherein the sixth partial region extends from the heat-conducting plate to the cooling cover.

6. The battery module according to claim 1, wherein the battery module comprises at least one electrically insulating film which is arranged in the space, and which:
is arranged at least on the first terminal region of the first stack side between the first terminal region and the heat-conducting compound located in the first partial region, and in particular also on the second terminal region of the first stack side between the second terminal region and the heat-conducting compound located in the third partial region; and or is arranged on a side of the cooling cover or of the heat-conducting plate facing the cell stack.

7. The battery module according to claim 1, wherein the module housing has two side walls, which are arranged essentially perpendicular to the third direction and which are each materially connected to the heat-conducting plate, in particular are welded to it.

8. The battery module according to claim 1, wherein the battery module has at least one spacer made of an electrically insulating material, which is arranged on the first stack side, in particular in the second partial region.

9. The battery module according to claim 1, wherein the battery module comprises at least one height tolerance compensating fastening means, by means of which the cooling cover is fastened to a housing component of the module housing.

10. A method for producing a battery module for a motor vehicle, including the following steps:
providing a cell stack arranged in a receptacle with a first stack side and with a plurality of battery cells arranged next to one another in a first direction, each of which having a first cell side which delimits the respective battery cell in a second direction and on which at least one first pole terminal of a respective battery cell, which is part of the first stack side or faces the first stack side, is arranged; and
providing a cooling cover through which a coolant can flow;
providing a heat-conducting compound; and
arranging the heat-conducting compound, the cell stack and the cooling cover relative to one another in such a way that the cooling cover is opposite the first stack side and a space is formed between the first stack side and the cooling cover, in which at least part of the heat-conducting compound is arranged,
wherein arranging takes place in such a way that the space is only partially filled with the heat-conducting compound, so that at least a contiguous first partial region of the space, which is located between the first pole terminals and the cooling cover, is completely filled with the heat-conducting compound, and wherein a second partial region of the space, which adjoins the first partial region with respect to a third direction, represents a collecting region for the heat-conducting compound and is at most only partially filled with the heat-conducting compound.

11. The battery module according to claim 2, wherein the battery module has a sealing frame arranged circularly around the space or a partial space encompassed by the same, in particular along an edge region of the first stack side.

12. The battery module according to claim 2, wherein the battery module has a heat-conducting plate arranged in the space, and which divides the space in the second direction into a first partial space and a second partial space, wherein the first partial region and the second partial region, and in particular also the third partial region, are arranged in the first partial space between the heat conduction plate and the first stack side.

13. The battery module according to claim 3, wherein the battery module has a heat-conducting plate arranged in the space, and which divides the space in the second direction into a first partial space and a second partial space, wherein the first partial region and the second partial region, and in particular also the third partial region, are arranged in the first partial space between the heat conduction plate and the first stack side.

14. The battery module according to claim 2, wherein in the second partial space:
a fourth partial region is arranged in the second direction directly above the first partial region, which is filled with a heat-conducting compound, in particular wherein the fourth partial region extends from the heat-conducting plate to the cooling cover; and/or
a fifth partial region is arranged in the second direction directly above the second partial region, which is at most only partially filled with a heat-conducting compound; and/or
a sixth partial region is arranged in the second direction directly above the first partial region, which is filled with a heat-conducting compound, in particular wherein the sixth partial region extends from the heat-conducting plate to the cooling cover.

15. The battery module according to claim 3, wherein in the second partial space:
a fourth partial region is arranged in the second direction directly above the first partial region, which is filled with a heat-conducting compound, in particular wherein the fourth partial region extends from the heat-conducting plate to the cooling cover; and/or
a fifth partial region is arranged in the second direction directly above the second partial region, which is at most only partially filled with a heat-conducting compound; and/or
a sixth partial region is arranged in the second direction directly above the first partial region, which is filled with a heat-conducting compound, in particular wherein the sixth partial region extends from the heat-conducting plate to the cooling cover.

16. The battery module according to claim 4, wherein in the second partial space:
a fourth partial region is arranged in the second direction directly above the first partial region, which is filled with a heat-conducting compound, in particular wherein the fourth partial region extends from the heat-conducting plate to the cooling cover; and/or
a fifth partial region is arranged in the second direction directly above the second partial region, which is at most only partially filled with a heat-conducting compound; and/or
a sixth partial region is arranged in the second direction directly above the first partial region, which is filled with a heat-conducting compound, in particular wherein the sixth partial region extends from the heat-conducting plate to the cooling cover.

17. The battery module according to claim 2, wherein the battery module comprises at least one electrically insulating film which is arranged in the space, and which:
is arranged at least on the first terminal region of the first stack side between the first terminal region and the heat-conducting compound located in the first partial region, and in particular also on the second terminal region of the first stack side between the second terminal region and the heat-conducting compound located in the third partial region; and or
is arranged on a side of the cooling cover (18) or of the heat-conducting plate facing the cell stack.

18. The battery module according to claim 3, wherein the battery module comprises at least one electrically insulating film which is arranged in the space, and which:
is arranged at least on the first terminal region of the first stack side between the first terminal region and the heat-conducting compound located in the first partial region, and in particular also on the second terminal region of the first stack side between the second terminal region and the heat-conducting compound located in the third partial region; and or
is arranged on a side of the cooling cover or of the heat-conducting plate facing the cell stack.

19. The battery module according to claim 4, wherein the battery module comprises at least one electrically insulating film which is arranged in the space, and which:
is arranged at least on the first terminal region of the first stack side between the first terminal region and the heat-conducting compound located in the first partial region, and in particular also on the second terminal region of the first stack side between the second terminal region and the heat-conducting compound located in the third partial region; and or
is arranged on a side of the cooling cover or of the heat-conducting plate facing the cell stack.

20. The battery module according to claim 5, wherein the battery module comprises at least one electrically insulating film which is arranged in the space, and which:
is arranged at least on the first terminal region of the first stack side between the first terminal region and the heat-conducting compound located in the first partial region, and in particular also on the second terminal region of the first stack side between the second terminal region and the heat-conducting compound located in the third partial region; and or
is arranged on a side of the cooling cover or of the heat-conducting plate facing the cell stack.
